(19) United States
(12) Patent Application Publication
(10) Pub. No.: US 2010/0202388 A1
(43) Pub. Date: Aug. 12, 2010

(54) OVER-THE-AIR ENHANCEMENT FOR BACKHAUL DYNAMIC INTERFERENCE MANAGEMENT IN WIRELESS NETWORKS

(75) Inventors: Ritesh K. Madan, Jersey City, NJ (US); Jaber M. Borran, San Diego, CA (US); Aamod D. Khandekar, San Diego, CA (US); Naga Bhushan, San Diego, CA (US); Ashwin Sampath, Skillman, NJ (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/698,358

(22) Filed: Feb. 2, 2010

Related U.S. Application Data
(60) Provisional application No. 61/149,642, filed on Feb. 3, 2009.
(60) Provisional application No. 61/180,707, filed on May 22, 2009.

(51) Int. Cl. H04W 72/04

(52) U.S. Cl. 370/329

(57) ABSTRACT

Techniques for allocation resources in a wireless communications network are provided.

### CLAIM OF PRIORITY UNDER 35 U.S.C. §119

The present Application for patent claims benefit of U.S. Provisional Patent Application Ser. No. 61/149,642, entitled, “Method and Apparatus for Hybrid Over-the-Air and Backhaul Based Interference Management in a Wireless Communication System,” filed Feb. 3, 2009; and U.S. Provisional Patent Application Ser. No. 61/180,707, entitled, “Systems and Methods of Hybrid Over-the-Air and Backhaul Based Interference Management in Wireless Communication Systems,” filed May 22, 2009; and are assigned to the assignee hereof and hereby expressly incorporated by reference herein.

### BACKGROUND

1. Field

Certain aspects of the present disclosure relate to wireless communications and, more particularly, to management of wireless connections.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels. Each of the NS independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

### SUMMARY

Certain embodiments provide a method for conveying resource allocation information in a wireless communications network. The method generally includes transmitting a first message via a backhaul connection, the first message comprising resource negotiation information for use in allocating over-the-air (OTA) resources of the wireless communications network and transmitting a second message via an OTA connection, the second message comprising supplemental information to supplement the resource negotiation information of the first message.

Certain embodiments provide a method for allocating resources of a wireless communications network. The method generally includes receiving a first message via a backhaul connection, the first message comprising resource negotiation information for use in allocating over-the-air (OTA) resources of the wireless communications, receiving a second message via an OTA connection, the second message comprising supplemental information to supplement the resource negotiation information of the first message, and allocating OTA resources based on the resource negotiation information and the supplemental information.

Certain embodiments provide an apparatus for conveying resource allocation information in a wireless communications network. The apparatus generally includes logic for transmitting a first message via a backhaul connection, the first message comprising resource negotiation information for use in allocating over-the-air (OTA) resources of the wireless communications network and logic for transmitting a second message via an OTA connection, the second message comprising supplemental information to supplement the resource negotiation information of the first message.

Certain embodiments provide an apparatus for allocating resources of a wireless communications network. The apparatus generally includes logic for receiving a first message via a backhaul connection, the first message comprising resource negotiation information for use in allocating over-the-air (OTA) resources of the wireless communications, logic for receiving a second message via an OTA connection, the second message comprising supplemental information to supplement the resource negotiation information of the first message, and logic for allocating OTA resources based on the resource negotiation information and the supplemental information.

Certain embodiments provide an apparatus for conveying resource allocation information in a wireless communications network. The apparatus generally includes means for transmitting a first message via a backhaul connection, the first message comprising resource negotiation information for use in allocating over-the-air (OTA) resources of the wireless communications network and means for transmitting a second message via an OTA connection, the second message comprising supplemental information to supplement the resource negotiation information of the first message.

Certain embodiments provide an apparatus for allocating resources of a wireless communications network. The apparatus generally includes means for receiving a first message via a backhaul connection, the first message comprising resource negotiation information for use in allocating over-the-air (OTA) resources of the wireless communications, means for receiving a second message via an OTA connection, the second message comprising supplemental information to supplement the resource negotiation information of the first message, and means for allocating OTA resources based on the resource negotiation information and the supplemental information.

Certain embodiments provide a computer-program product for conveying resource allocation information in a wireless communications network, comprising a computer readable medium having instructions stored thereon, the instructions being executable by one or more processors. The instructions generally include instructions for transmitting a first message via a backhaul connection, wherein the instructions for the first message comprise resource negotiation information for use in allocating over-the-air (OTA) resources of the wireless communications network and instructions for transmitting a second message via an OTA connection, wherein the instructions for the second message comprise supplemental information to supplement the resource negotiation information of the first message.

Certain embodiments provide a computer-program product for conveying resource allocation information in a wireless communications network, comprising a computer readable medium having instructions stored thereon, the instructions being executable by one or more processors. The instructions generally include instructions for receiving a first message via a backhaul connection, wherein the instructions for the first message comprise resource negotiation information for use in allocating over-the-air (OTA) resources of the wireless communications, instructions for receiving a second message via an OTA connection, the second message comprising supplemental information to supplement the resource negotiation information of the first message, and instructions for allocating OTA resources based on the resource negotiation information and the supplemental information.

Certain embodiments provide an apparatus for conveying resource allocation information in a wireless communications network. The apparatus generally includes at least one processor configured to transmit a first message via a backhaul connection, the first message comprising resource negotiation information for use in allocating over-the-air (OTA) resources of the wireless communications network and transmit a second message via an OTA connection, the second message comprising supplemental information to supplement the resource negotiation information of the first message.

Certain embodiments provide an apparatus for allocating resources of a wireless communications network. The apparatus generally includes at least one processor configured to receive a first message via a backhaul connection, the first message comprising resource negotiation information for use in allocating over-the-air (OTA) resources of the wireless communications, receive a second message via an OTA connection, the second message comprising supplemental information to supplement the resource negotiation information of the first message, and allocate OTA resources based on the resource negotiation information and the supplemental information.

### BRIEF DESCRIPTION OF THE DRAWINGS

FIG. 1 illustrates an example wireless communication system.

FIG. 2 illustrates a block diagram of an example access point and user terminal.

FIG. 3 illustrates an example wireless communication system having multiple access points, in accordance with certain aspects of the present disclosure.

FIGS. 4 and 5 illustrate example operations that may be performed by access points to coordinate resource allocation, in accordance with certain aspects of the present disclosure.

FIGS. 4A and 5A illustrate example components capable of performing operations shown in FIGS. 4 and 5.

FIG. 6 is an example timing diagram showing example coordination in accordance with certain aspects of the present disclosure.

### DETAILED DESCRIPTION

Certain techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE) or Evolved UTRA.

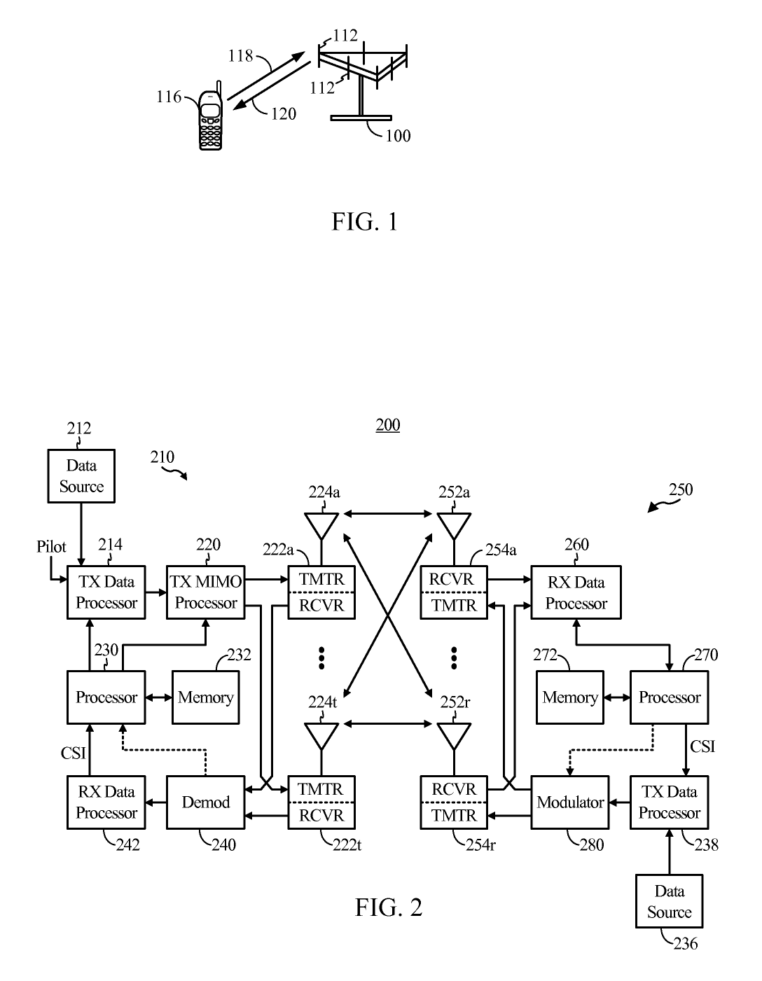

Referring to FIG. 1, a multiple access wireless communication system according to one embodiment is illustrated. An access point 100 (AP) may include multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 transmit information to access terminal 116 over forward link 120 and receive information from access terminal 116 over reverse link 118. In a FDD system, communication links may use different frequency for communication. For example, forward link 120 may use a different frequency then that used by reverse link 118.

An access point may be a fixed station used for communicating with the terminals and may also be referred to as an access point, a Node B, an evolved Node B (eNode B), or some other terminology. An access terminal may also be called an access terminal, user equipment (UE), a wireless communication device, terminal, access terminal or some other terminology.

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250. Processor 230 then determines which pre-coding matrix to use for determining the beamforming weights then processes the extracted message.

In an aspect, logical channels are classified into Control Channels and Traffic Channels. Logical Control Channels comprise Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels compries a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Data Channel (UL-SDCH) and a plurality of PHY channels. The PHY channels comprise a set of DL channels and UL channels

The DL PHY channels may comprise, for example, a Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), and a Paging Indicator Channel (PICH), Load Indicator Channel (LICH).

The UL PHY Channels may comprise, for example, a Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), and Broadband Pilot Channel (BPICH).

### Over-the-Air Enhancement for Backhaul Dynamic Interference Management in Wireless Networks

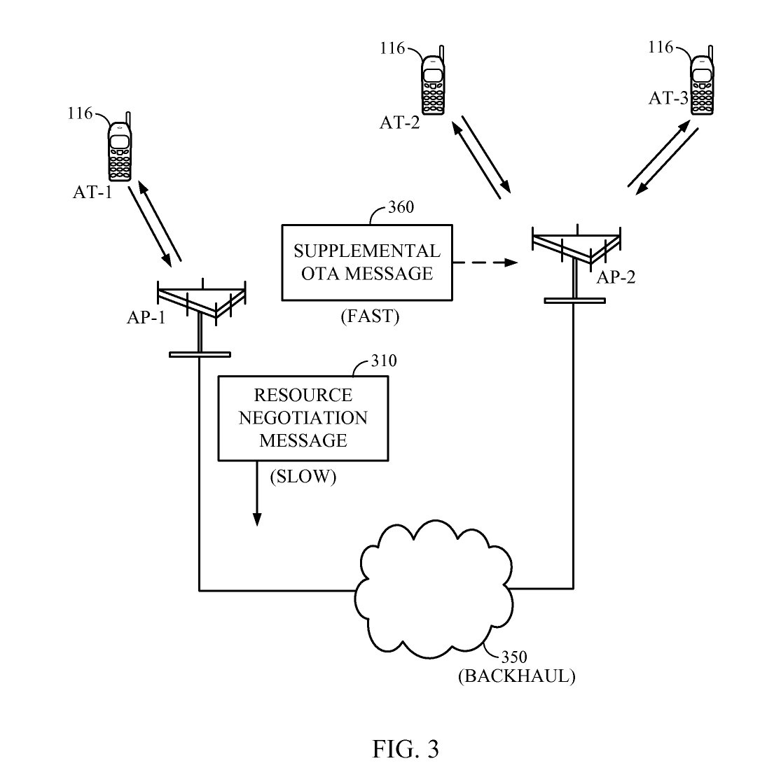

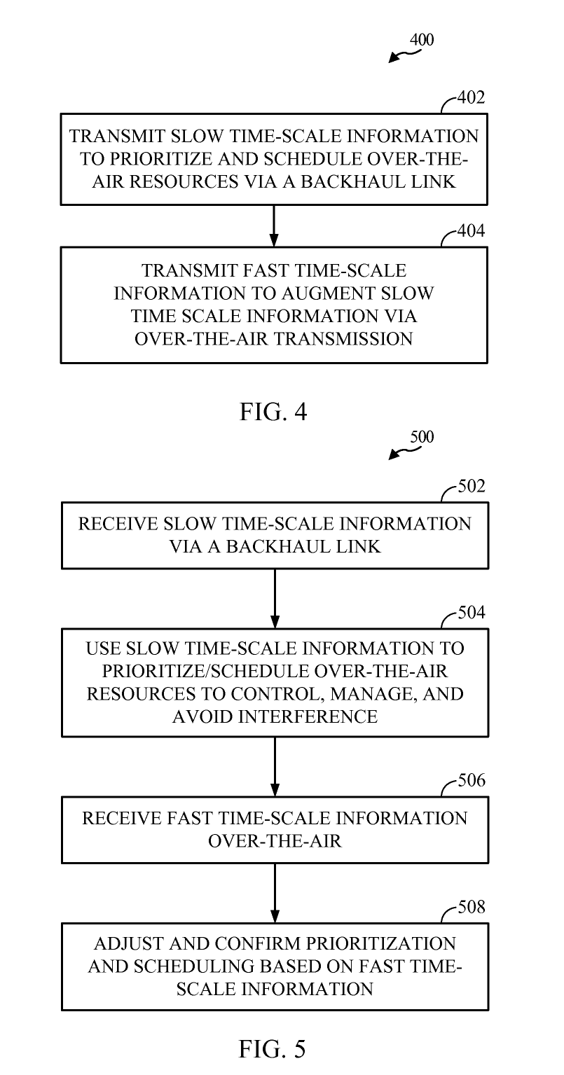

FIG. 3 illustrates an example multiple access wireless communication system with multiple access points 100, AP-1 and AP-2. In the illustrated example, AP-1 serves a single access terminal (AT-1), while AP-2 serves two ATs, AT-2 and AT-3. According to certain aspects, one or more of the APs may be Femtocell or picocell base stations, for example, established to provide service in an area that is not covered by traditional cellular service.

Such deployments may be relatively unplanned and lack the defined geometry of traditional cellular base station deployments. As a result, a transmission from AP-1 may interfere with a transmission from AP-2. In an effort to reduce interference, AP-1 and AP-2 may coordinate communications and resource allocation.

According to certain aspects of the present disclosure, each AP may periodically exchange resource negotiations messages 310 over a backhaul link 350. These messages may contain various types of information to help schedule and/or prioritize transmissions, such as information about channel conditions, interference at the receiver, and QoS parameters of traffic flows.

An AP may utilize information received in such messages to decide, in a decentralized manner, the resources over which it should send/receive data in a manner that reduces interference with transmissions from other APs. In order to avoid interference, transmission frequencies and transmit power may be made with fairness in mind, while still attempting to satisfy QoS requirements.

Because the backhaul connection 350 is typically capable of high data throughput and is generally not bandwidth-limited, a relatively large amount of information may be exchanged in resource negotiation messages, which may help allow for intelligent decisions regarding resource allocation. For example, according to certain embodiments, a backhaul connection 350 may be a wired Internet Protocol (IP) connection.

Unfortunately, however, the backhaul connection 350 may be controlled by one or more third parties (e.g., one or more service providers), which may result in high variability in delay in delivering resource negotiation messages. Delayed reception of resource negotiation messages may result in resource allocation decisions being made based on stale information (e.g., information that reflects outdated channel conditions).

An inability to guarantee the “freshness” of information in the resource negotiation messages may diminish the ability of the APs to effectively coordinate the efficient allocation of spectral resources for data transmission. For example, stale information may cause an AP to unnecessarily refrain (“back off”) from transmitting its own data to keep from interfering with transmissions of another AP, resulting in reduced bandwidth utilization.

According to certain aspects of the present disclosure, however, APs may augment the information sent in conventional resource negotiation messages (delivered over relatively slow backhaul links) with information delivered in supplemental over the air (OTA) messages 360.

Because the supplemental messages 360 are sent OTA, the delay between the time the supplemental message is sent and the time at which the supplemental message is received may be much smaller than the corresponding delay for the resource negotiation messages 310 sent over the backhaul 350. However, because spectral resources are typically considered scarce, OTA messaging may be bandwidth-limited, and it may be desirable to limit OTA messages to a relatively small amount of information. As will be described in greater detail below, according to certain aspects, an AP may send single bit in a supplemental OTA message 360 to indicate whether a transmit buffer is full and there is still a need for resources.

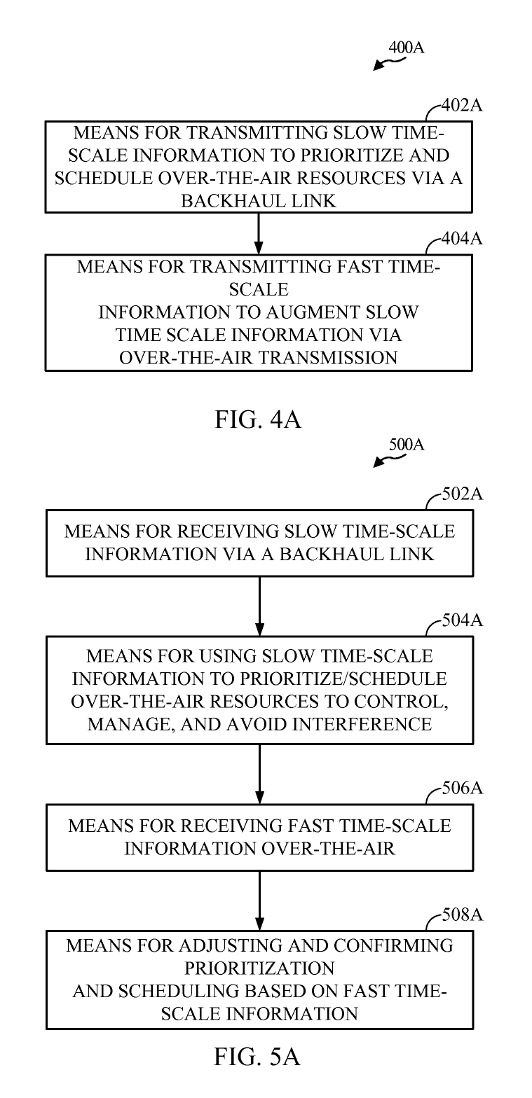

FIG. 4 illustrates example operations 400 that may be performed by access points to coordinate resource allocation. The illustrated operations may be performed by any suitable components, such as the APs described above with reference to FIGS. 1-3.

The operation 400 begin, at 402, by transmitting information (e.g., relatively slow time-scale information) to prioritize and schedule over-the-air (OTA) resources over a backhaul link. For example, referring to FIG. 3 above, AP-1 may transmit slow time-scale information via a backhaul connection using resource negotiation messages 360 to AP-2.

At 404, “supplemental” fast time-scale information is transmitted via an OTA message to augment the slow time scale information. As shown in FIG. 3, AP-1 may transmit fast time-scale information via one or more OTA messages 360 to AP-2. According to certain aspects, the fast time-scale information may be periodically broadcast and contained in a relatively small number of bits, such as a buffer non-empty flag. AP-1 may transmit the fast time-scale information via any suitable mechanism, for example, using one of the prescribed control channels in a LTE network, such as BCCH, PCCH, MCCH and DCCH. For other types of networks, any other suitable channels may be used for the supplemental OTA messaging.

In any case, by augmenting the information sent via the backhaul link, which may have substantial delay, with supplemental information sent via an OTA link, AP-1 may help ensure that AP-2 does not use “stale” information for resource allocation.

FIG. 5 illustrates example operations 500 that may be performed by an access point to coordinate resource allocation based on slow time information, received over a backhaul link, augmented with OTA messaging. For example, the operations 500 may be performed by an AP receiving the messages sent by an AP performing the operations 400 described above.

The operations begin, at 502, by receiving slow time-scale information, via a backhaul link. At 504, the slow time-scale information may be used to allocate (e.g., prioritize/schedule) OTA resources, for example, in an effort to avoid interference. At 506, fast time-scale information is received OTA. At 508, the allocated OTA resources are confirmed or adjusted based on the fast time-scale information.

Referring to FIG. 3, upon receiving messages that indicate that AP-1 may be suffering from poor QoS, AP-2 may respond by “backing-off” its links to allow AP-1 to transmit. According to certain aspects, an AP may adjust resource allocation by lowering the priority of its transmissions and re-scheduling its data transmissions to a later time.

According to certain aspects, AP-2 may use the fast time-scale information to adjust and/or confirm the priority and scheduling of allocated resources. The fast time-scale information may provide AP-2 “fresher” information regarding the state of the communication network than the slow time-scale information received via the backhaul connection. According to certain aspects, in response to received fast time-scale information, AP-2 may override scheduled use of spectral resources or disregard incoming “stale” slow time-scale information.

As a simple example mentioned above, an AP may send one or two bits representing a transmit buffer “non-empty” flag to confirm the AP still has data to send in its transmit buffer. In other words, upon receiving an indication the transmitting AP still has data to transmit, the receiving AP may “back-off” and refrain from allocating resources in a manner that might result in interference. On the other hand, upon receiving an indication that the buffer is empty, the receiving AP may free-up previously allocated resources. Of course, more complex signaling may also be available via OTA messaging if additional bits are used, albeit at the expense of resource consumption.

According to certain aspects, bits in OTA message may be used to signal traffic priority. In such cases, one or more OTA bits may be used to signal a high priority for pending traffic that has low packet delay targets (e.g., with a specified maximum latency). For example, one or more OTA bits may be used to flag a packet as high priority if the packet arrives at a time t, and needs to be send out before a later time (t+delta), where delta is smaller than backhaul latency.

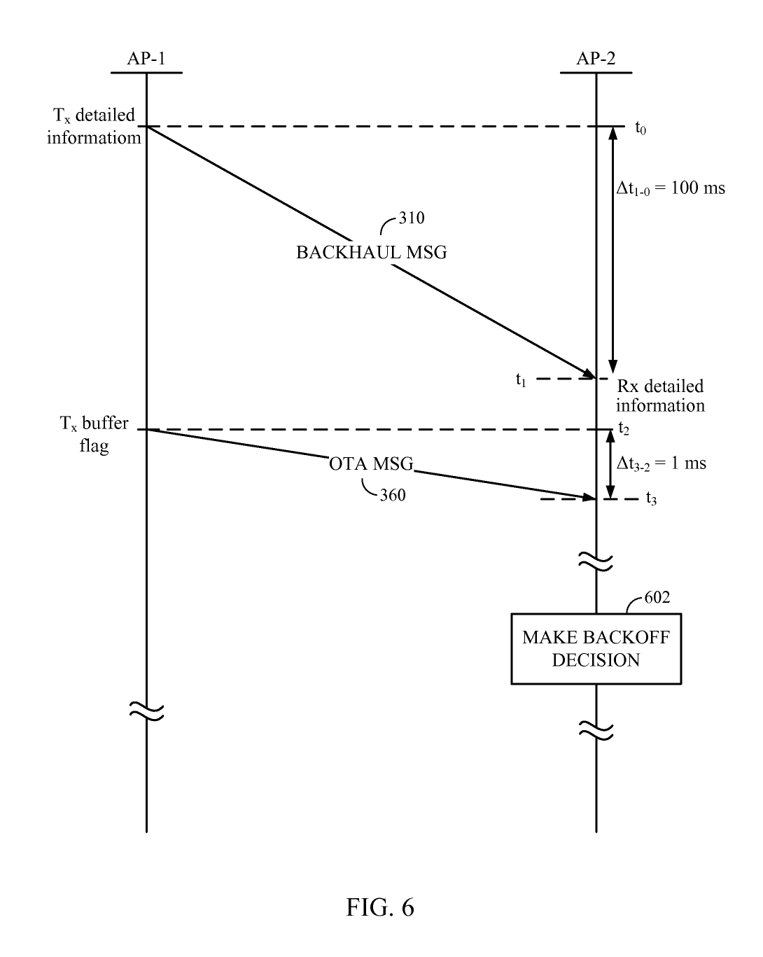

FIG. 6 illustrates an example communication exchange 600 between multiple access points, AP-1 and AP-2, using OTA messages to augment information sent in backhaul messages.

In the illustrated example, AP-1 may transmit, at time t₀, a resource negotiation message 310 containing detailed information via a backhaul connection. AP-2 receives the resource negotiation message 310, at time at time t₁. Due to delay in the backhaul connection, the delay between t₁ and t₀, Δt₁₋₀, may be significant (Δt₁₋₀ is illustrated as 100 ms) and, thus, the information received in the resource negotiation message 310 may become stale.

Therefore, in order to augment the information contained in the resource negotiation message 310, AP-2 may transmit an OTA message 360. As illustrated, the delay between transmitting the OTA message 360 (at t₂) and its reception (at t₃), may be much less than for the resource negotiation message 310 (Δt₃₋₂ is illustrated as 1 ms). Thus, AP-2 may the information contained in the OTA message is “fresh” and AP-2 may use this information, for example, when making a backoff decision at 602.

According to certain aspects, responsive to the detailed information received via the backhaul connection and the buffer non-empty flag bits received via over-the-air transmissions, APs may make a determination of whether to “back-off” a link in order to control, manage, and/or avoid interference with the other access point. According to certain aspects, each access point may back off from allocating resources only when the OTA messages indicate links with non-empty buffers at any given time. This scheme may help ensure efficient use of limited spectral resources.

The various operations of methods described above may be performed by various hardware and/or software component(s) and/or module(s) corresponding to means-plus-function blocks illustrated in the Figures. For example, blocks 400 and 500 illustrated in FIGS. 4 and 5 correspond to means-plus-function blocks 400A and 500A illustrated in FIGS. 4A and 5A.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

1. A method for conveying resource allocation information in a wireless communications network, comprising:
transmitting a first message via a backhaul connection, the first message comprising resource negotiation information for use in allocating over-the-air (OTA) resources of the wireless communications network; and
transmitting a second message via an OTA connection, the second message comprising supplemental information to supplement the resource negotiation information of the first message.

2. The method of claim 1, wherein the resource negotiation information comprises at least one of: an average interference metric, channel state information, or quality of service (QoS) information.

3. The method of claim 1, wherein the supplemental information comprises one or more bits indicating whether a transmitting device has a pending packet in a transmit buffer.

4. The method of claim 3, wherein:
the pending packet has a maximum specified latency; and
the one or more bits comprise at least one bit indicating a high priority of the pending packet.

5. The method of claim 1, wherein the second message comprises one or more bits indicating priorities for data traffic comprising at least one of radio resource control (RRC) signaling message, an access response message, a paging message, or a paging response message.

6. A method for allocating resources of a wireless communications, comprising:
receiving a first message via a backhaul connection, the first message comprising resource negotiation information for use in allocating over-the-air (OTA) resources of the wireless communications;
receiving a second message via an OTA connection, the second message comprising supplemental information to supplement the resource negotiation information of the first message; and
allocating OTA resources based on the resource negotiation information and the supplemental information.

7. The method of claim 6, wherein the allocating comprises:
scheduling resources based on the resource negotiation information; and
at least one of confirming or adjusting the scheduling based on the supplemental information.

8. The method of claim 6, wherein the resource negotiation information comprises at least one of: an average interference metric, channel state information, or quality of service (QoS) information.

9. The method of claim 6, wherein the supplemental information comprises one or more bits indicating whether a transmitting device has a pending packet in a transmit buffer.

10. The method of claim 9, wherein:
the pending packet has a maximum specified latency; and
the one or more bits comprise at least one bit indicating a high priority of the pending packet.

11. The method of claim 6, wherein the second message comprises one or more bits indicating priorities for data traffic comprising at least one of radio resource control (RRC) signaling message, an access response message, a paging message, or a paging response message.

12. An apparatus for conveying resource allocation information in a wireless communications network, comprising:
logic for transmitting a first message via a backhaul connection, the first message comprising resource negotiation information for use in allocating over-the-air (OTA) resources of the wireless communications network; and
logic for transmitting a second message via an OTA connection, the second message comprising supplemental information to supplement the resource negotiation information of the first message.

13. The apparatus of claim 12, wherein the resource negotiation information comprises at least one of: an average interference metric, channel state information, or quality of service (QoS) information.

14. The apparatus of claim 12, wherein the supplemental information comprises one or more bits indicating whether a transmitting device has a pending packet in a transmit buffer.

15. The apparatus of claim 14, wherein:
the pending packet has a maximum specified latency; and
the one or more bits comprise at least one bit indicating a high priority of the pending packet.

16. The apparatus of claim 12, wherein the second message comprises one or more bits indicating priorities for data traffic comprising at least one of radio resource control (RRC) signaling message, an access response message, a paging message, or a paging response message.

17. An apparatus for allocating resources of a wireless communications network, comprising:
logic for receiving a first message via a backhaul connection, the first message comprising resource negotiation information for use in allocating over-the-air (OTA) resources of the wireless communications network;
logic for receiving a second message via an OTA connection, the second message comprising supplemental information to supplement the resource negotiation information of the first message; and
logic for allocating OTA resources based on the resource negotiation information and the supplemental information.

18. The apparatus of claim 17, wherein the logic for allocating comprises logic for scheduling resources based on the resource negotiation information and at least one of confirming or adjusting scheduling of resources based on the supplemental information.

19. The apparatus of claim 17, wherein the resource negotiation information comprises at least one of: an average interference metric, channel state information, or quality of service (QoS) information.

20. The apparatus of claim 17, wherein the supplemental information comprises one or more bits indicating whether a transmitting device has a pending packet in a transmit buffer.

21. The apparatus of claim 20, wherein:
the pending packet has a maximum specified latency; and
the one or more bits comprise at least one bit indicating a high priority of the pending packet.

22. The apparatus of claim 17, wherein the second message comprises one or more bits indicating priorities for data traffic comprising at least one of radio resource control (RRC) signaling message, an access response message, a paging message, or a paging response message.

23. An apparatus for conveying resource allocation information in a wireless communications network, comprising:
means for transmitting a first message via a backhaul connection, the first message comprising resource negotiation information for use in allocating over-the-air (OTA) resources of the wireless communications network; and
means for transmitting a second message via an OTA connection, the second message comprising supplemental information to supplement the resource negotiation information of the first message.

24. An apparatus for allocating resources of a wireless communications network, comprising:
means for receiving a first message via a backhaul connection, the first message comprising resource negotiation information for use in allocating over-the-air (OTA) resources of the wireless communications network;
means for receiving a second message via an OTA connection, the second message comprising supplemental information to supplement the resource negotiation information of the first message; and
means for allocating OTA resources based on the resource negotiation information and the supplemental information.

25. A computer-program product for conveying resource allocation information in a wireless communications network, comprising a computer readable medium having instructions stored thereon, the instructions being executable by one or more processors and the instructions comprising:
instructions for transmitting a first message via a backhaul connection, wherein the instructions for the first message comprise resource negotiation information for use in allocating over-the-air (OTA) resources of the wireless communications network; and
instructions for transmitting a second message via an OTA connection, wherein the instructions for the second message comprise supplemental information to supplement the resource negotiation information of the first message.

26. A computer-program product for allocating resources of a wireless communications network, comprising a computer readable medium having instructions stored thereon, the instructions being executable by one or more processors and the instructions comprising:
instructions for receiving a first message via a backhaul connection, wherein the instructions for the first message comprise resource negotiation information for use in allocating over-the-air (OTA) resources of the wireless communications network;
instructions for receiving a second message via an OTA connection, the second message comprising supplemental information to supplement the resource negotiation information of the first message; and
instructions for allocating OTA resources based on the resource negotiation information and the supplemental information.

27. An apparatus for conveying resource allocation information in a wireless communications network, comprising at least one processor configured to:
transmit a first message via a backhaul connection, the first message comprising resource negotiation information for use in allocating over-the-air (OTA) resources of the wireless communications network; and
transmit a second message via an OTA connection, the second message comprising supplemental information to supplement the resource negotiation information of the first message.

28. An apparatus for allocating resources of a wireless communications network, comprising at least one processor configured to:
receive a first message via a backhaul connection, the first message comprising resource negotiation information for use in allocating over-the-air (OTA) resources of the wireless communications network;
receive a second message via an OTA connection, the second message comprising supplemental information to supplement the resource negotiation information of the first message; and
allocate OTA resources based on the resource negotiation information and the supplemental information.
